(19) United States
(12) Patent Application Publication
(10) Pub. No.: US 2010/0150329 A1
(43) Pub. Date: Jun. 17, 2010

(54) DISTRIBUTED ORDER PROCESSING

(75) Inventors: Sunil Kumar, Tampa, FL (US); Josy John, Wesley Chapel, FL (US); Premanand Sivakkolundhu, Tampa, FL (US); Maruf Ahmed, Tampa, FL (US)

Correspondence Address: VERIZON;PATENT MANAGEMENT GROUP, 1320 North Court House Road, 9th Floor, ARLINGTON, VA, 22201-2909, US

(73) Assignee: VERIZON DATA SERVICES LLC, Temple Terrace, FL (US)

(21) Appl. No.: 12/333,574

(22) Filed: Dec. 12, 2008

(51) Int. Cl. H04M 3/42

(52) U.S. Cl. 379/201.12

(57) ABSTRACT

A computer-readable medium may include computer-executable instructions. The computer-executable instructions may include instructions for receiving, from a provisioning unit, an order pertaining to a set of telephone numbers and an address, separating the order into sub-orders, each sub-order corresponding to each of the telephone numbers, sending one of the sub-orders to a catalog server over a message, a telephone number that corresponds to the one sub-order being outside of a rate center to which the address belongs, receiving a response from the catalog server, and sending a reply to the order to the provisioning unit.

### BACKGROUND INFORMATION

An order provisioning system may perform many tasks. For example, an order provisioning system may provide a price list and/or product description, enter orders from customers, and process orders. The system also may provide a web interface to those who wish to track order filling or problem resolution (e.g., product unavailability).

### BRIEF DESCRIPTION OF THE DRAWINGS

FIG. 1 shows an exemplary network in which concepts described herein may be implemented;

FIG. 2 is a block diagram of exemplary components of a network device of FIG. 1;

FIG. 3 is a block diagram of functional components of an order distribution gateway of FIG. 1 according to an exemplary implementation;

FIG. 4 shows an exemplary structure of a message database of FIG. 3 in accordance with one exemplary implementation;

FIG. 5 shows tables in an order database of FIG. 3 in accordance with one exemplary implementation;

FIG. 6 is a block diagram of functional components of a catalog server of FIG. 3 in accordance with one exemplary implementation;

FIG. 7 is a diagram illustrating an exemplary communication process between components in FIGS. 3-6;

FIG. 8 is a flow diagram of an exemplary process associated with the order distribution gateway and the catalog server of FIG. 3;

FIG. 9 is a flow diagram of an exemplary process associated with a timeout handler of FIG. 3;

FIG. 10 depicts an exemplary client application window for requesting information associated with an order from the order distribution gateway of FIG. 1;

FIG. 11 depicts another exemplary client window for displaying details of a particular order; and

FIG. 12 depicts yet another exemplary window for showing information associated with processing an order.

### DETAILED DESCRIPTION OF PREFERRED EMBODIMENTS

The following detailed description refers to the accompanying drawings. The same reference numbers in different drawings may identify the same or similar elements. As used herein, the term “middleware message” may refer to a message whose delivery is ensured by a robust communication mechanism/protocol (e.g., transactional mechanism/protocol). For example, if a middleware message is sent to a recipient program that terminates abnormally prior to receiving the message, an underlying middleware application that supports the robust communication protocol or transport mechanism may repeatedly resend the message until the recipient program recovers and receives the message.

As used herein, the term “synchronized queue” may refer to a queue whose concurrent access is protected by a synchronization mechanism, such as a mutex, semaphore (e.g., a counting semaphore. a binary semaphore, etc.), a lock, a wait-for-object, a spin lock, test-and-set, compare-and-swap, etc.

Implementations described herein relate to an order distribution and tracking system. As described below, the system may receive an order from a remote device, separate the order into sub-orders, send the sub-orders to database servers, receive responses from the database servers, and send a reply to the remote device. In performing these tasks, the system may use a robust communication mechanism to interact with the database servers and the remote device.

In some implementations, the above system may be used to receive orders that are related to telephone numbers. In one implementation, each order may request the system to assign a set of telephone numbers to an address or a customer. The address/customer can be outside or inside of a rate center that is associated with the area code of the telephone number.

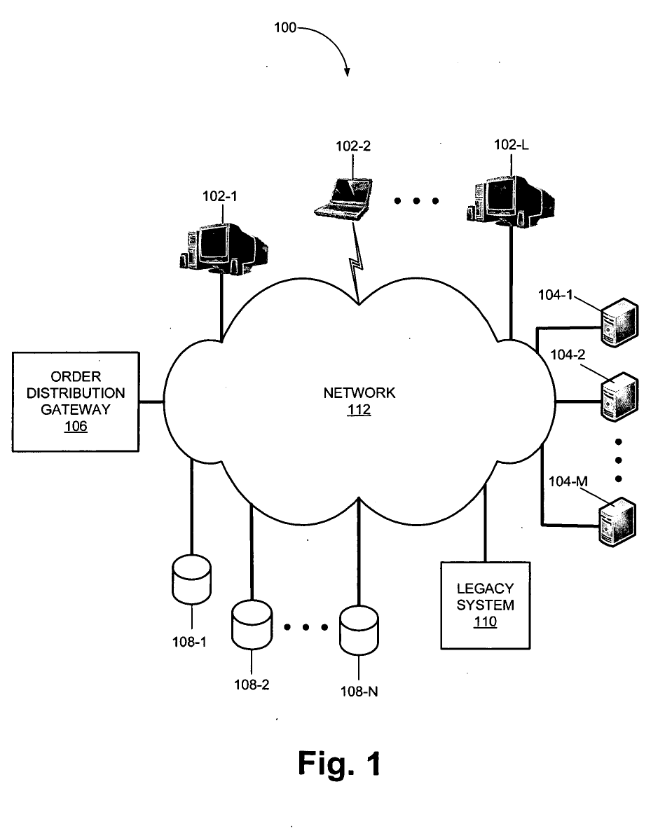

FIG. 1 shows an exemplary network in which concepts described herein may be implemented. As shown, network 100 may include client devices 102-1 through 102-L (herein collectively referred to as client devices 102 and individually as client device 102-x), provisioning platforms 104-1 through 104-M (herein collectively referred to as provisioning platforms 104 and individually as provisioning platform 104-x), an order distribution gateway 106, catalog servers 108-1 through 108-N (herein collectively referred to as catalog servers 108 and individually as catalog server 108-x), a legacy system 110, and a network 112.

Because network 100 is illustrated partly to provide clarity in description, network 100 does not show other network components, such as routers, switches, etc. In addition, depending on the implementation, network 100 may include fewer, additional, or different devices than those illustrated in FIG. 1. For example, in one implementation, network 100 may not include legacy system 110.

Client device 102-x may include a client application that interacts with provisioning platform 104-x or order distribution gateway 108. Via the client application hosted on client device 102-x, a user may place an order at provisioning platform 104-x or determine the status of an order at order distribution gateway 108. Depending on the implementation, via the client application, the user may place an order for tangible or intangible goods/services (e.g., a manufactured product, a widget, produce (e.g., an apple), a service (e.g., an assignment of a telephone number to a user or an address)), etc.). For example, in some implementations, a user may place an order for a telephone number to be assigned to the user or to an address. In one implementation, the user may request up to 36 numbers to be assigned to the user or the address.

Provisioning platform 104-x may include one or more server applications for receiving an order from client device 102-x and relaying the order to order distribution gateway 108. In one implementation, four provisioning platforms 104 may be located in four different geographical areas (e.g., a northern United States (US), eastern US, western US, and southern US) to serve client devices 102 therein.

Order distribution gateway 106 may include one or more devices to receive an order from provisioning platform 104-x, separate the order into sub-orders, send the sub-orders to catalog servers 108, receive responses from catalog servers 108, and send a reply to provisioning platform 104-x. For example, assume that provisioning platform 104-x sends an order for a basket of fruit to order distribution gateway 106. Order distribution gateway 106 may separate the order into sub-orders for apples, bananas, pears, and a basket. In addition, order distribution gateway may send each of the sub-orders to a corresponding catalog server 108-x (e.g., a catalog server for handling a banana sub-order). When catalog servers 108 fill the sub-orders and respond to order distribution gateway 106, order distribution gateway 106 may send a reply to provisioning platform 104-x, indicating that the order has been filled, and notify appropriate parties (e.g., workers who are to combine the fruits and the basket).

In a different example, assume that provisioning platform 104-x sends an order to validate whether a set of telephone numbers are correctly assigned to a user/address, for a Voice-over-Internet Protocol (VoIP) service. Order distribution gateway 106 may separate the order into sub-orders, each of which corresponds to one of the telephone numbers, and send each of the sub-orders to corresponding catalog server 108-x (e.g., a catalog server that handles a specific set of phone numbers). When each of catalog servers 108 validates the assignment of a telephone numbers to the address and responds to order distribution gateway 106, order distribution gateway 106 may send a reply to provisioning platform 104-x, indicating that the telephone numbers are correctly assigned. In this example, the telephone numbers may belong to different rate centers (e.g., a geographical area that is used to distinguish rate boundaries in which calls are rated (priced) the same).

Catalog server 108-x may include components to receive a sub-order from order distribution gateway 106, perform an action associated with filling the sub-order, and send a reply to order distribution gateway 106. The reply may indicate whether the sub-order has been successfully filled.

For example, assume that each catalog server 108-x includes a database of telephone numbers that are associated with a particular geographical region (e.g., one or more states (e.g., California, Maryland, Virginia, etc.)). In such a case, catalog server 108-x may receive an order to assign a telephone number to a user/address, determine whether the telephone number is available for the user/address, assign the telephone number to the user/address, and send a reply to order distribution gateway 106.

In another example, catalog server 108-x may receive an order for pens, send an instruction to a warehouse where pens are to be physically packaged and shipped, receive a confirmation from the warehouse that the pens have been shipped, and send a reply to order distribution gateway 106 that the sub-order has been filled.

Depending on the implementation, the number and locations of catalog servers 108 may vary. For example, assume that catalog server 108-x includes a database (e.g., catalog of inventory of telephone numbers, pens, produce, etc.) to service an area within a geographical region. In such an instance, many catalog servers 108 may be employed to cover the geographical region (e.g., 13 catalog servers 108 to provide telephone numbers in 35 states).

Legacy system 110 may include a device for submitting orders to catalog servers 108 via legacy mechanisms. For example, assume that catalog server 108-x includes an inventory of telephone numbers and addresses. In such instances, legacy system 110 may request catalog server 108-x to assign a telephone number to a plain old telephone system (POTS) customer via a legacy application/interface, provided that the requested telephone number and the customer belong to the same rate center.

Network 112 may include one or more wired and/or wireless networks that are capable of exchanging information, such as voice, video, documents, multimedia, text, etc. For example, network 112 may include one or more public switched telephone networks (PSTNs) or another type of switched network. Network 112 may also include one or more wireless networks and may include a number of transmission towers for receiving wireless signals and forwarding the wireless signals toward the intended destination. Network 112 may further include one or more packet switched networks, such as an Internet protocol (IP) based network, a local area network (LAN), a wide area network (WAN), a personal area network (PAN), an intranet, the Internet, or another type of network that is capable of exchanging information.

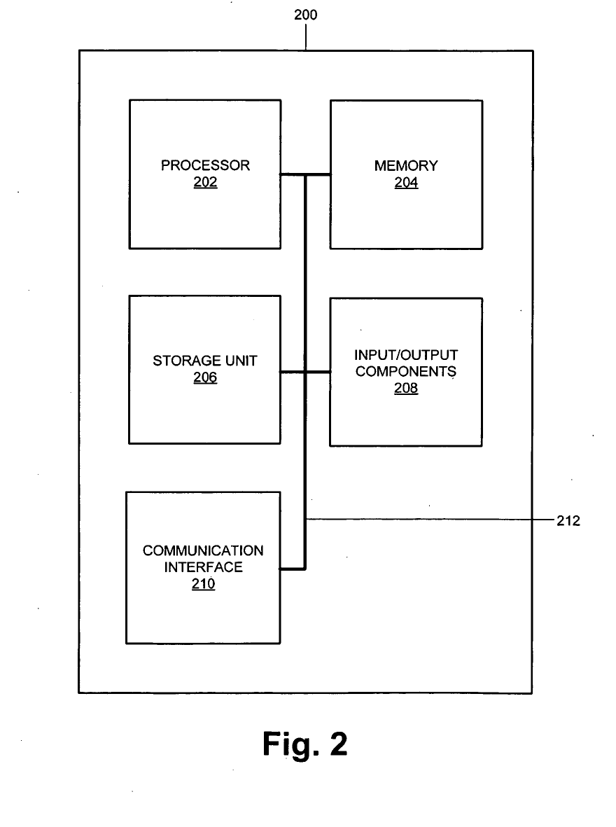

FIG. 2 is a block diagram of exemplary components of a network device 200. Network device 200 may represent client device 102-x and/or a device in provisioning platform 104-x, order distribution gateway 106, and/or catalog server 108-x. As shown, network device 200 may include a processor 202, memory 204, storage unit 206, input/output components 208, communication interface 210, and bus 212.

Processor 202 may include one or more processors, microprocessors, application specific integrated circuits (ASICs), field programmable gate arrays (FPGAs), or other processing logic that may interpret and execute instructions. Memory 204 may include static memory, such as read only memory (ROM), and/or dynamic memory, such as random access memory (RAM), or onboard cache, for storing data and machine-readable instructions. Storage unit 206 may include a magnetic and/or optical storage/recording medium. In some implementations, storage unit 206 may be mounted under a directory tree or mapped to a drive.

Input/output components 208 may include a display (e.g., a cathode ray tube, a liquid crystal display (LCD), an organic light emitting diode (OLED) display, etc.), a keyboard, a mouse, a speaker, a microphone, a Digital Video Disk (DVD) writer, a DVD reader, Universal Serial Bus (USB) ports, and/or other types of components for converting physical events or phenomena to and/or from digital signals that pertain to network device 200.

Communication interface 210 may include any transceiver-like mechanism that enables network device 200 to communicate with other devices and/or systems. For example, communication interface 210 may include mechanisms for communicating via a network, such as a wireless network. In these implementations, communication interface 210 may include one or more radio frequency (RF) transmitters, receivers and/or transceivers and one or more antennas for transmitting and receiving RF data. For example, communication interface 210 may include a radio or television tuner, a mobile telephone transceiver, etc. Communication interface 210 may also include a modem or an Ethernet interface to a LAN or other network for communicating with other devices. Bus 212 may provide an interface through which components of network device 100 can communicate with one another.

In FIG. 2, network device 200 is illustrated as including components 202-212 partly to advance clarity in description. In an actual implementation, network device 200 may include additional, fewer, or different components. For example, network device 200 may include one or more power supplies, fans, motherboards, video cards, etc.

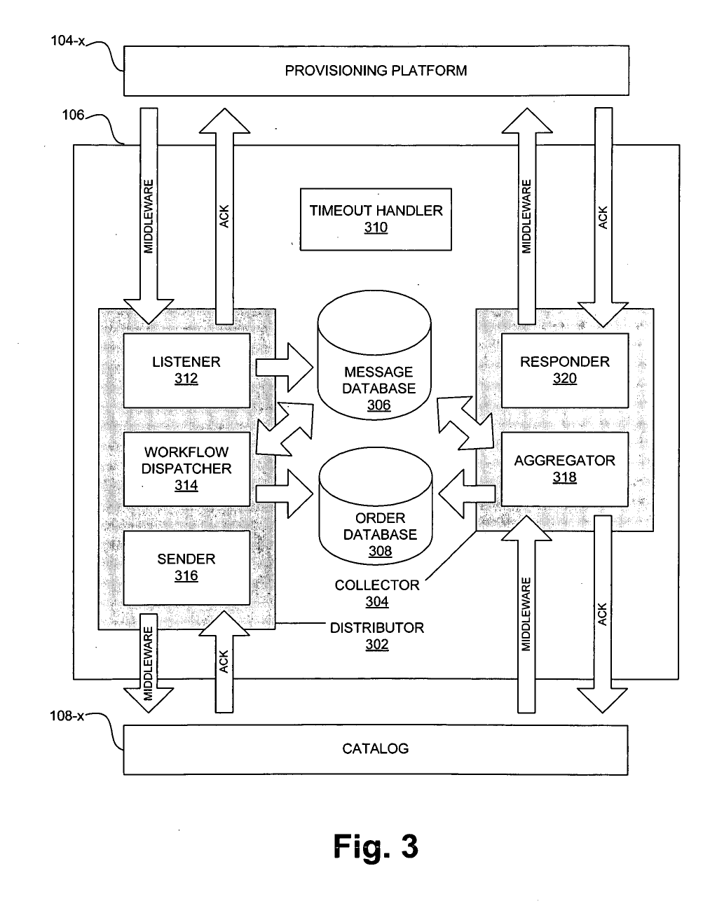

FIG. 3 is a block diagram of functional components of order distribution gateway 106 according to an exemplary implementation. As shown, order distribution gateway 106 may include a distributor 302, a collector 304, a message database 306, an order database 308, and a timeout handler 310. Distributor 302 may receive an order from provisioning platform 104-x, separate the order into sub-orders, and send the sub-orders to corresponding catalog servers 108. Collector 304 may collect responses from catalog servers 108 and reply to provisioning platform 104-x.

Message database 306 may store information that pertains to messages. Depending on the implementation, message database 306 may be implemented as a document, a file structure, a relational database, etc. and may include different organizational structures and subcomponents.

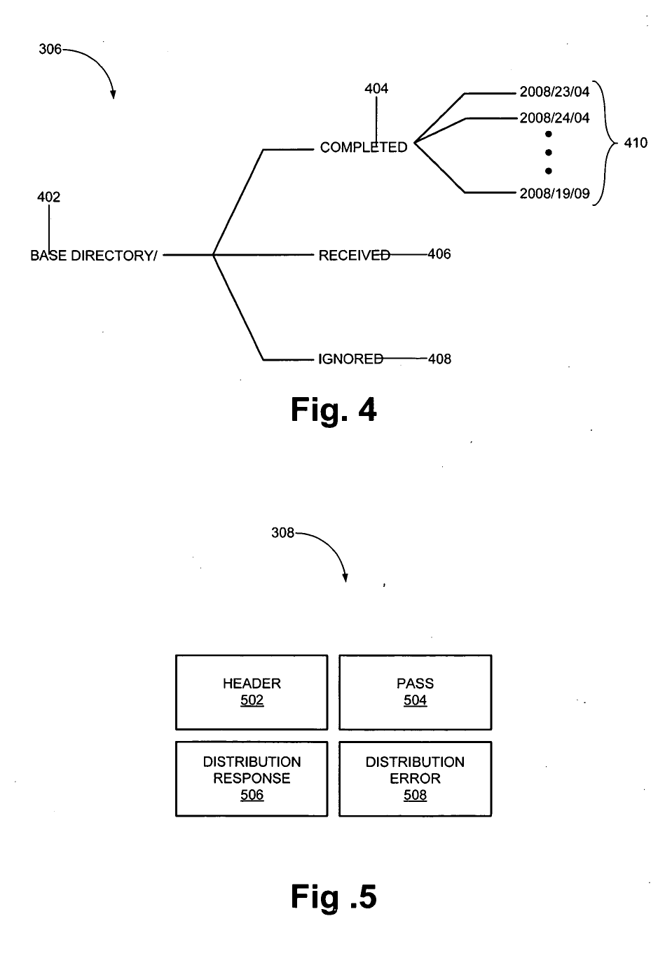

FIG. 4 shows a structure of message database 306 according to one exemplary implementation. In this implementation, message database 306 may take the form of a directory. As shown, message database 306 may include a base directory 402, a completed directory 404, a received directory 406, and an ignored directory 408. Base directory 402 may provide a directory under which other directories 404-408 may be located. Completed directory 404 may include sub-directories 410, each of whose names is in the format “YYYY/MM/DD.” Sub-directories 410 may include files, each of which refers to a specific order.

For example, one of subdirectories 410 may include a file whose name contains the following strings: an order number (e.g., 15 characters), a transaction number (e.g., 10 characters), and timestamp (e.g., 10 characters). The order number may include a number that is associated with a particular order and is provided by provisioning platform 104-x. The transaction number may include a number that is associated with a single incidence of interaction (e.g., a request to modify an order) between provisioning platform 104-x and order distribution gateway 106. The timestamp may include the time at which the order is received at order distribution gateway 106.

For an example of a filename, assume that an order no., a transaction no., and a timestamp are 000000000000081, 0000000099, and September 10, 2008, 1:00 p.m., respectively. A corresponding filename may be “000000000000081_{—}0000000099_{—}1221051600,” where “1221051600” corresponds to September 10, 2008 in UNIX time.

Received directory 406 and ignored directory 408 may include directories for containing files that correspond to orders that are received and ignored, respectively. Order distribution system 106 may ignore an order for various reasons (e.g., an invalid requested phone number). Received directory 406 and ignored directory 408 may be organized in a manner similar to that described above with respect to completed directory 404.

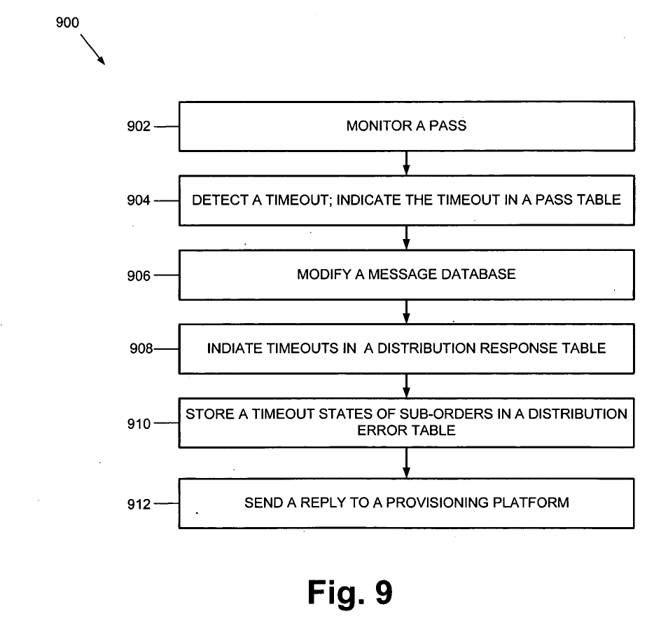

Returning to FIG. 3, order database 308 may include tables that are associated with processing orders. Order database 308 may be implemented as a document, a file structure, a relational database, etc. and may include different organizational structures and subcomponents. Timeout handler 310 may monitor each order for a fixed period of time. If an order is not processed within that period, timeout handler 310 may take appropriate actions, as described below with reference to FIG. 9.

FIG. 5 shows order database 308 according to one exemplary implementation. As shown, order database 308 may include a header table 502, a pass table 504, a distribution response table 506, and a distribution error table 508. Header table 502 may include bookkeeping information that is associated with a particular order, such as a transaction number, a geographical location associated with the order, order status, etc. Pass table 504 may include information about a specific processing that is associated with an order. After order distribution gateway 106 receives an order from provisioning platform 104-x, provisioning platform 104-x may send a request to modify the order to order distribution gateway 106. In such an instance, order distribution gateway 106 may make an additional pass to process the order.

Distribution response table 506 may track each of sub-orders. Distribution response table 506 may indicate whether each sub-order results in a successful, failed, or timed-out processing. Distribution error 508 may include information for sub-orders that either timed out or failed to complete for particular reasons.

Returning to FIG. 3, distributor 302 may include a listener 312, a workflow dispatcher 314, and a sender 316. Listener 312 may include a component (e.g., a software component) for receiving a middleware message from provisioning platform 104-x. For each middleware message that listener 312 receives, listener 312 may reply with an acknowledgement, create and place a file in a dated directory under received directory 406, and send a message to workflow dispatcher 314, to signal that an order has been received.

Workflow dispatcher 314 may include a component to obtain information about an order from message database 306, store bookkeeping information for the order in header table 502, and store information pertaining to a particular pass in pass table 504. In addition, workflow dispatcher 314 may separate (e.g., split) the order into sub-orders, store information related to the sub-orders in distribution response table 506, and place each of the sub-orders in a queue (not shown in FIG. 3). Each queue may temporarily store sub-orders that are to be delivered to corresponding catalog server 108-x.

Sender 316 may include a component for retrieving a sub-order from a queue and sending the sub-order to catalog server 108-x via a middleware message.

As further shown in FIG. 3, collector 304 may include an aggregator 318 and a responder 320. Aggregator 318 may include a component for receiving a middleware message from catalog server 108-x, sending an acknowledgment to catalog server 108-x, and determining whether a particular pass or attempt corresponding to the sub-order has timed out. In addition, aggregator 318 may indicate, in distribution response table 506, whether a particular sub-order has been successfully filled, failed to be performed, and/or timed out. If aggregator 318 detects an error in processing, aggregator 318 may record the error in distribution error table 508. Responder 320 may include a component to send a reply to provisioning platform 104-x, indicating whether an order has been filled, timed out, or failed to be filled based on a message from aggregator 318.

Although FIG. 3 shows order distribution gateway 106 as including components 302-318, depending on the implementation, order distribution gateway 106 may include additional, fewer, or different components in similar or different arrangements. In addition, components 302-318 may be hosted on a single network device 200 or distributed over many network devices 200.

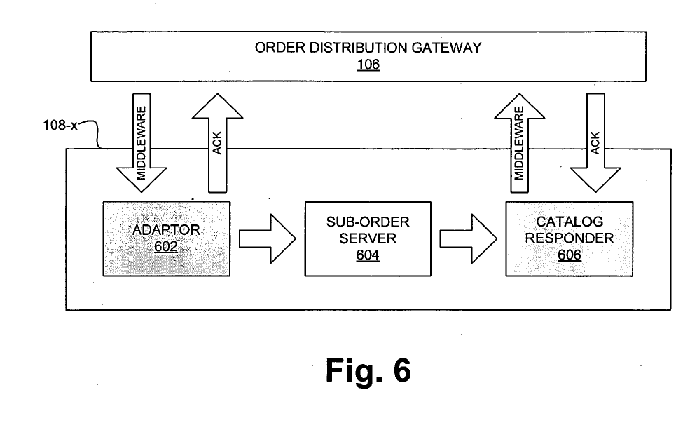

FIG. 6 is a block diagram of functional components of catalog server 108-x in accordance with one exemplary implementation. As shown, catalog server 108-x may include an adaptor 602, a sub-order server 604, and a catalog responder 606. Depending on the implementation, catalog server 108-x may include additional, fewer, or different components than those illustrated in FIG. 6. For example, catalog server 108-x may include scripts for handling requests from legacy system 110.

Adaptor 602 may include a component for receiving a sub-order from order distribution gateway 106 via a middleware message and sending an acknowledgement to order distribution gateway 106. In addition, adaptor 602 may submit the sub-order to sub-order server 604. In submitting the sub-order, adaptor 602 may rewrite the middleware message in a format that sub-order server 604 will accept.

Sub-order server 604 may include components for receiving a sub-order from adaptor 602, performing a task associated with the sub-order, and providing a message to catalog responder 606. Depending on the implementation, the task may include, for example, shipping a product, retrieving a piece of information (e.g., a telephone number, an indication that the telephone number is available), etc.

Catalog responder 606 may include a component for receiving a message from sub-order server 604, rewriting the message in a different format, and transmitting the rewritten response to order distribution gateway 106 via a middleware message. Subsequently, catalog responder 606 may receive an acknowledgment from order distribution gateway 106.

In FIGS. 3-6, various components may communicate with one another in various ways. For example, workflow dispatcher 314, aggregator 318, and sub-order server 604 may communicate with sender 316, responder 320, and catalog responder 606, respectively, via FIRST-IN-FIRST-OUT (FIFO) synchronized message queues. Use of FIFO synchronized queues may ensure the reliability of communication (e.g., guaranteed delivery of messages) between the components, and allow order distribution gateway 106 to recognize and manage communication problems (e.g., unresponsiveness).

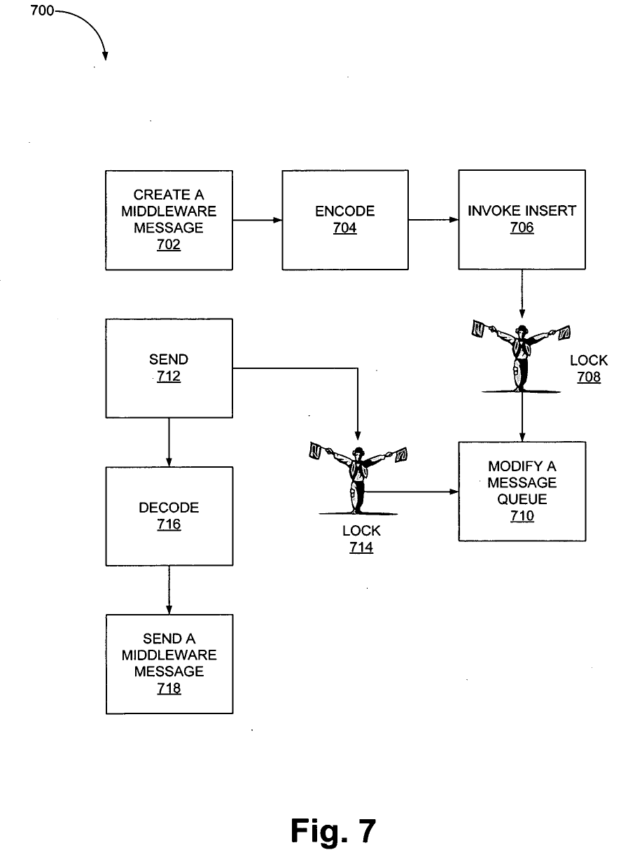

FIG. 7 is a diagram illustrating a communication process 700 between the components in FIGS. 3-6 that use a FIFO message queue. As shown, communication process 700 may start with a server (e.g., workflow dispatcher 314, aggregator 318, sub-order server 604, etc.) creating a middleware message (block 702). Subsequently, the server may encode the middleware message (block 704), for security purposes.

The server may invoke an interface to insert the encoded message into a synchronized message queue (block 706). The invocation of the interface may cause a request for an exclusive lock (e.g., increment a counting semaphore, obtain a spin-lock, etc.) on the queue to be dispatched.

The server may acquire the exclusive lock (e.g., a semaphore) on the queue (block 708). By acquiring the lock, the server may prevent another component from modifying the queue while the server is in the middle of inserting the encoded message in the queue.

When the server acquires the lock, the server may modify the queue (block 710) by inserting the encoded message. After the encoded message is inserted, the server may release the lock (i.e., unlock (e.g., decrement a semaphore count)) and send notifications to other components, indicating that the lock has been released.

Each message that is in the queue may wait until the message is removed from the queue to be sent to an intended destination. A removal may start at block 712, where a second server (e.g., sender 316) invokes an interface to send a message stored in the queue (block 712). Invoking the interface may cause the second server to lock the queue (block 714). By acquiring the lock, the second server may prevent another component from modifying the queue.

After the second server locks the queue, the second server may decode a message in the queue (block 716). When the message is decoded, the second server may send the decoded message to a remote server (e.g., adaptor 612) (block 718), which may reply with an acknowledgment. After the acknowledgment is received, the second server may remove the message from the queue. Subsequently, the second server may release the lock and notify other components that the lock is free to be acquired.

Although process 700 is described above with reference to workflow dispatcher 314 and sender 316, process 700 may be implemented to ensure the reliability of communication between other components, such as communication between aggregator 318 and responder 320, between sub-order server 604 and catalog responder 606, etc. In addition, although the synchronized queue is described above with reference to obtaining a lock, a different mechanism for synchronizing multiple processes/threads may used. For example, two or more semaphores may be used to synchronize multiple processes/threads (e.g., increment a semaphore when inserting a message and decrement a semaphore when deleting a message, etc.).

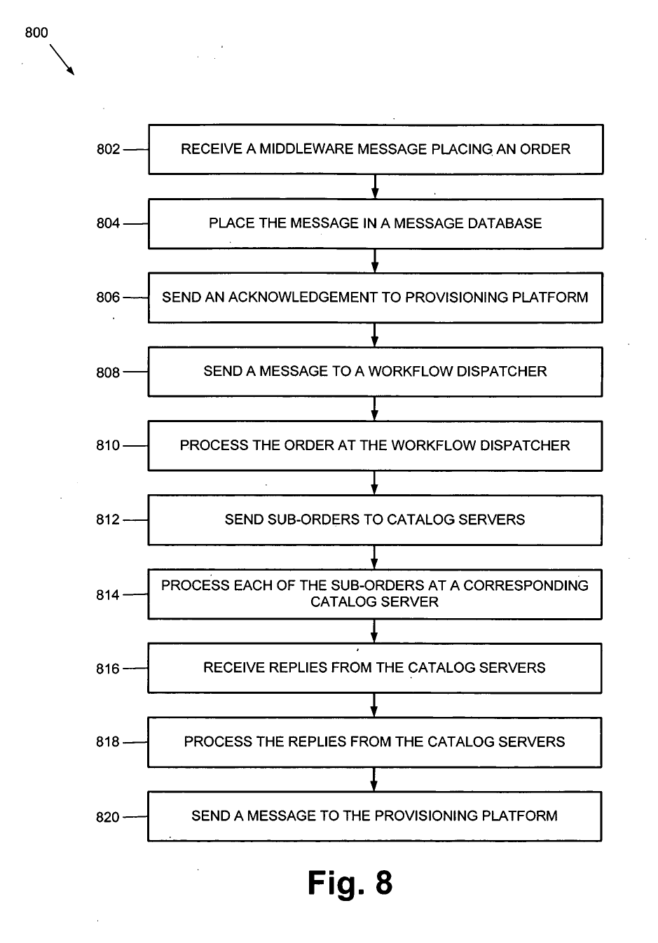

FIG. 8 is a flow diagram of an exemplary process 800 associated with order distribution gateway 106 and catalog server 108-x. Assume that provisioning platform 104-x has sent a middleware message to order distribution gateway. As shown in FIG. 8, process 800 may start with listener 312 receiving the middleware message (block 802).

Listener 312 may create a record in message database 306 (block 804). For example, assume that the message sent by provisioning platform 104-x places an order on November 12, 2008, and that the order requests order distribution gateway 106 to assign a particular telephone number to a customer. Also assume that message database 306 in order distribution gateway 106 is implemented as illustrated in FIG. 4. In such a case, in response to the middleware message, listener 312 may create a record (e.g., a file) named “0000000149_{—}0000000493_{—}1226498400,” where “0000000149” corresponds to an order number, “0000000493” to a transaction number, and “1226498400” to November 12, 2008 in UNIX time.

Listener 312 may send an acknowledgment message to provisioning platform 104-x (block 806). If provisioning platform 104-x does not receive an acknowledgment from listener 312, provisioning platform 104-x may assume that listener 312 has not received the middleware message. In such an instance, provisioning platform104-x may resend the middleware message.

Listener 312 may send a message to workflow dispatcher 314 (block 808). When workflow dispatcher 314 receives the message from listener 312, workflow dispatcher 314 may begin to process the order. In one implementation, the message may include the filename created at block 804.

Workflow dispatcher 314 may process the order (block 810). More specifically, workflow dispatcher 314 may store header and pass information for the order in header table 502 and pass table 504, split the order into sub-orders, and store information associated with the sub-orders in distribution response table 506. In addition, workflow dispatcher 314 may place each of the sub-orders in a FIFO synchronized message queue, via process 700 described above.

For example, assume that provisioning platform 104-x places an order for two phone numbers, 301-432-1129 and 202-411-2349 on November 12, 2008, and that the order number is 111112222233333. In addition, assume that listener 312 creates a file corresponding to the order in message database 306. Consequently, workflow dispatcher 314 may store the order number 111112222233333 and “November 12, 2008” in header table 502, and store a string “processing,” for example, in pass table 504 to indicate that the order is being processed. In addition, workflow dispatcher 314 may split the order into two sub-orders, one sub-order for the telephone number 301-432-1129 and the other sub-order for the telephone number 202-411-2349. Accordingly, workflow dispatcher 314 may create entries for the sub-orders in distribution response table 506.

In creating the entries, workflow dispatcher 314 may classify each of the sub-orders based on the identity of catalog server 108-x that is to fill the sub-order. Assume, for example, that catalog server 108-1 manages telephone numbers for Maryland and catalog server 108-2 manages telephone numbers for the District of Columbia. Also, assume that the name of catalog server 108-1 is CP01. In such an instance, the sub-order corresponding to the telephone number 301-432-1129 may be classified as CP01. In the preceding example, each area code is in Numbering Plan Area-NXX-XXXX (NPA-NXX-XXXX) format, where N is any number between 2 through 9, and each of the last six digits XX-XXXX is any number between 0 through 9.

Returning to FIG. 8, once workflow dispatcher 314 splits the order into the sub-orders, workflow dispatcher 314 may create and place middleware messages that correspond to the sub-orders in FIFO synchronized message queues. The process for inserting a message into the message queue is described above with respect FIG. 7.

At block 812, sender 316 may send each of the sub-orders to respective catalog servers (block 812). The process for sending a middleware message from the message queue is described above with respect FIG. 7.

Each catalog server 108-x may process a corresponding sub-order (block 814). When a sub-order arrives at catalog server 108-x, adaptor 602 may place the sub-order at sub-order server 604 and send an acknowledgment to sender 316. In placing the sub-order at sub-order server 604, adaptor 602 may create and send a message to sub-order server 604 in a form (e.g., series of commands in structured query language (SQL)) that sub-order server 604 can parse.

After receiving the sub-order from adaptor 602, sub-order server 604 may perform one or more tasks that are associated with the sub-order. For example, assume that the sub-order requires the telephone number 301-432-1129 to be assigned to John Doe. In this case, sub-order server 604 may modify its database to assign the telephone number 301-432-1129 to John Doe.

In addition, sub-order server 604 may provide a result of performing the task (e.g., successful assignment of the telephone number 301-432-1129 to John Doe) to catalog responder 606. Accordingly, catalog responder 606 may parse the result from sub-order server 604, and send a reply to order distribution gateway 106. The reply may indicate whether sub-order server 604 successfully filled the sub-order, failed to fill the sub-order, or has timed out.

Aggregator 318 may receive replies from catalog servers 108 (block 816). Furthermore, aggregator 318 may process each of the replies. In processing each reply, aggregator 318 may send an acknowledgment to catalog server 108-x from which the reply originates, and examine, in pass table 504, a timeout status of the pass under which the order is being processed. If pass table 504 indicates a timeout, timeout handler 310, and aggregator 318 may stop processing the order.

If the pass has not timed out, aggregator 318 may update distribution response table 506. For each sub-order entry in distribution response table 506, aggregator 318 may indicate whether the sub-order is successfully filled or failed to be filled. If a reply from catalog server 108-x indicates an error in processing a particular sub-order, aggregator 318 may record the error in distribution error table 508.

If a reply from catalog server 108-x pertains to the last of the sub-orders into which an order has been separated, aggregator 318 may perform additional tasks. Aggregator 318 may place a message (e.g., a sequence of characters) to be sent to provisioning platform 104-x in distribution response table 506 and insert the message in a responder queue (not shown). Further, aggregator 318 may mark, in pass table 504, that the current pass is complete. In one implementation, aggregator 318 may also transfer a file that corresponds to the order from received directory 406 to completed directory 404.

Responder 320 may send the message in the responder queue to provisioning platform 104-x (block 820). In one implementation, responder 320 may send the message to provisioning platform 104-x's network address (e.g., IP address, a Universal Resource Locator (URL), etc.) that has been stored by workflow dispatcher 314.

In addition, responder 320 may wait for an acknowledgment from provisioning platform 104-x. Depending on the configuration, responder 320 may or may not wait for an acknowledgment from provisioning platform 104-x. For example, if a configuration parameter “wait for ACK” is set to “TRUE” in responder 320, responder 320 will wait for an acknowledgment from provisioning platform 104-x before deleting the stored message from the responder queue. Responder 320 will retry re-sending the message until an acknowledgment is received. If “wait for ACK” is set to “FALSE,” responder 320 will delete the message from the responder queue immediately after sending the message to provisioning platform 104-x.

FIG. 9 is a flow diagram of a process 900 associated with timeout handler 310 according to one implementation. As shown, timeout handler 310 may monitor a pass (block 902). In one implementation, timeout handler 310 may monitor the pass by examining database tables (e.g., distribution response table 506) in order database 308.

When timeout handler 310 detects a timeout (e.g., not all of sub-order entries of an order in distribution response table 506 have successfully completed or failed within a predetermined amount of time), timeout handler 310 may indicate, in pass table 504, that the current pass has timed out (block 904).

In addition, timeout handler 310 may modify message database 306 to reflect the timeout (block 906). For example, timeout handler 310 may move a file that corresponds to the order in received directory 406 to completed directory 404 in message database 306.

Timeout handler 310 may modify distribution response table 506 to indicate that all sub-orders associated with an order have timed out (block 908). For each sub-order entry associated with the order, timeout handler 310 may indicate that the sub-order has timed out. Furthermore, timeout handler 310 may record that the sub-orders have timed out in corresponding sub-order entries in distribution error table 508 (block 910).

Timeout handler 310 may send a response to provisioning platform 104-x, to convey that the order has timed out (block 912). For example, timeout handler 310 may send a message that states “Timeout: a pass has exceeded the maximum allowable time to complete the order and has timed out” to provisioning platform 104-x.

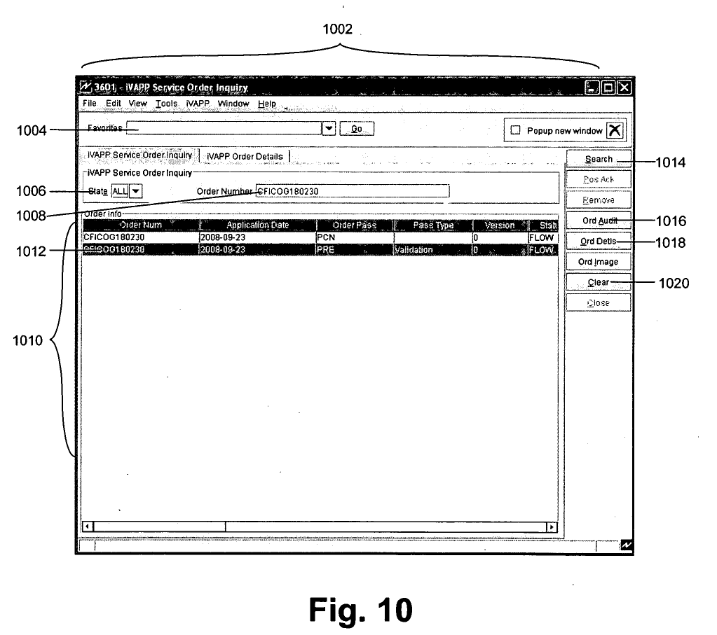

In the preceding, FIGS. 3-9 pertain to different devices, components, and/or processes that are associated with provisioning platform 104-x, order distribution gateway 106, and catalog servers 108. FIGS. 10-12 illustrate different graphical user interface (GUI) windows of a client application that is hosted on client device 102-x. The client application may allow the user to view and/or track flow of orders and their status at order distribution gateway 106. Depending on the implementation, each of the windows may include additional, fewer, or different components than those illustrated in FIGS. 10-12.

FIG. 10 depicts a client application window 1002 for requesting information associated with an order from order distribution gateway 106. Window 1002 may show overall status of an order and passes associated with the order. As depicted, window 1002 may include a favorites text box 1004, a state selection box 1006, a order number text box 1008, an order information pane 1010, an order entry 1012, a search button 1014, an order audit button 1016, an order detail button 1018, and a clear button 1020. Although FIG. 10 shows additional components, their description is omitted for purposes of simplicity.

Favorites text box 1004 may include a graphical user interface (GUI) component for entering text that allows window 1002 to change to a user's favorite view. Such a view may include, for example, a detailed view of a specific order, a view for searching an order etc. State selection box 1006 may include a list menu via which the user can select one or more geographical regions (e.g., Virginia, Maryland, etc.). Order number text box 1008 may include a text box into which a user can enter an order number for which the user can obtain information. Order information pane 1010 may display a list of passes/processes that are associated with an order. Order entry 1012 may provide information about a particular pass for the order (e.g., status of the pass). Search button 1014 may cause the client application to list, in order information pane 1010, order entries (e.g., sub-orders) that correspond to the order number in order number text box 1008. Order audit button 1016, when pressed, may cause the client application to display processing details that are associated with an order.

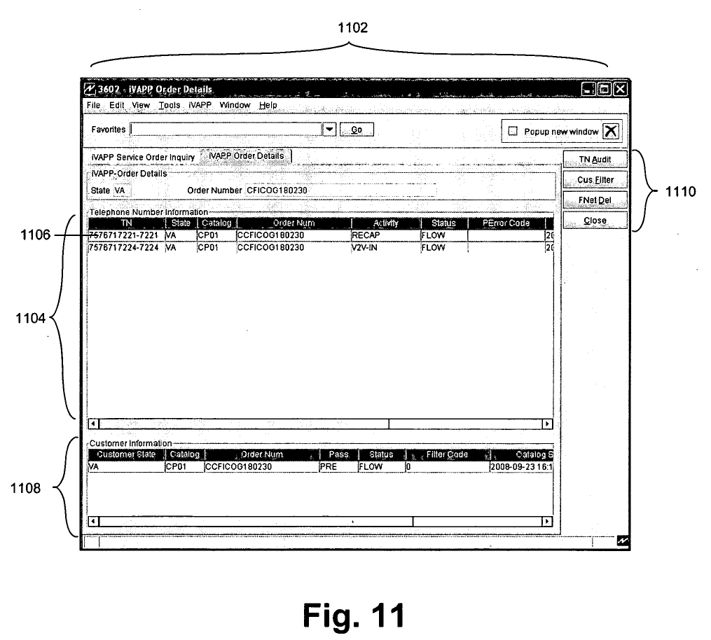

FIG. 11 depicts another client application window 1102. Via window 1102, a user may view details about each of the sub-orders that have been sent to catalog servers 108 (e.g., status of each sub-order in catalog server 108-x). As shown, window 1102 may include a sub-order pane 1104, a sub-order entry 1106, a customer information pane 1108, and action buttons 1110. Although FIG. 11 shows components in addition to components 1104-1110, their description is omitted for purposes of simplicity.

Sub-order pane 1104 may include a list of sub-orders in a current order, and sub-order entry 1106 may include details about a particular sub-order. For example, sub-order entry 1106 shows detailed information about a sub-order associated with telephone number 757-671-7221, such as the name of catalog server 108-x to which the sub-order is sent, the status of the sub-order in catalog server 108-x, a time at which the sub-order is received at catalog server 108-x, a response time at catalog server 108-x, etc. Customer information pane 1108 shows information associated with a customer, such as a geographical location (e.g., Virginia) in which the customer is located, an order number, etc. Action buttons 1110 may include buttons for initiating an action on a specific sub-order entry such as auditing a telephone number, closing viewing panes, etc.

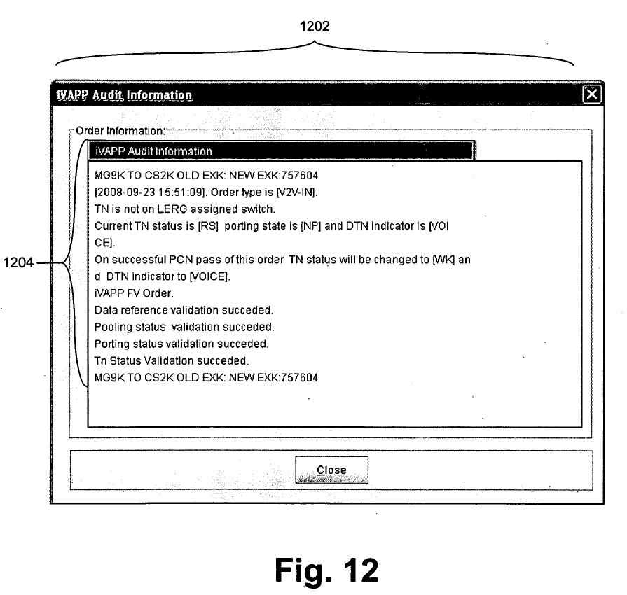

FIG. 12 depicts another client application window 1202. As shown, window 1202 may include a viewing pane 1202, which illustrates processing details that are associated with an order.

The above description relates to an order distribution and tracking system that includes client devices 102, provisioning platforms 104, order distribution gateway 106, and catalog servers 108. Order distribution gateway 106 may receive an order from provisioning platform 104-x, separate the order into constituent sub-orders, send each the sub-orders to catalog servers 108-x, receive responses to the sub-orders from catalog servers 108, and send a reply to provisioning platform 104-x. In performing these tasks, order distribution gateway 108 may use a reliable communication mechanism to interact with provisioning platform 104-x and catalog servers 108.

As described, in some implementations, the above system may be used to receive orders that are related to telephone numbers. In one implementation, each order may request the system to assign a set of telephone numbers to an address or a customer. The address/customer can be inside or outside of a rate center that is associated with the area code of the telephone number.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, a client application in client device 102-x and order distribution gateway 106 may include mechanisms for allowing a user to set a “bypass” flag. When the bypass flag is set, order distribution gateway 106 may send a positive response to provisioning platform 104-x with respect to an order, even though order distribution gateway 106 has not distributed corresponding sub-orders to catalog servers 108. The bypass functionality can be used when there are critical issues with catalog servers 108 and/or when catalog servers 108 need to be updated manually.

Further, while series of acts have been described with respect to FIGS. 7-9, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A computer-readable medium comprising computer-executable instructions, the computer-executable instructions including instructions for:
receiving, from a provisioning unit, an order associated with a set of telephone numbers and an address;
separating the order into sub-orders, each sub-order corresponding to each of the telephone numbers;
sending one of the sub-orders to a catalog server via a message, the one of the sub-orders corresponding to a telephone number that is outside of a rate center to which the address belongs;
receiving a response from the catalog server; and
sending a reply to the order to the provisioning unit.

2. The computer-readable medium of claim 1, wherein the instructions for receiving, from a provisioning unit, an order include instructions for:
receiving a second message from the provisioning unit; and
creating a record in a message database to indicate that the second message has been received.

3. The computer-readable medium of claim 1, wherein sending one of the sub-orders includes:
locking a queue;
encoding a second message;
inserting the encoded message into the queue; and
unlocking the queue.

4. The computer-readable medium of claim 3, wherein the instructions for locking the queue include instructions for:
incrementing a semaphore count.

5. The computer-readable medium of claim 1, wherein the instructions for sending a reply to the order to the provisioning unit include instructions for:
receiving an acknowledgement from the provisioning unit, to ensure that the provisioning unit has received the reply.

6. The computer-readable medium of claim 5, wherein the instructions for receiving the acknowledgment include instructions for:
receiving an indication of whether the reply is to be removed immediately from a queue that stores messages in case the messages need to be present.

7. The computer-readable medium of claim 1, further comprising instructions for:
assigning, at the catalog server, one of the telephone numbers to the address.

8. The computer-readable medium of claim 1, further comprising:
sending another one of the sub-orders to another catalog server via a second message, wherein the other one of the sub-orders corresponds to a telephone number that is inside of the rate center.

9. The computer-readable medium of claim 1, wherein the instructions for sending one of the sub-orders to a catalog server includes instructions for:
sending, to the catalog server, a task of validating whether a telephone number has been assigned to the address.

10. The computer-readable medium of claim 1, wherein the instructions for sending a reply to the order to the provisioning unit include instructions for:
indicating whether the order has been successfully filled.

11. A device comprising:
a listener configured to:
receive an order, via a first message, from a remote provisioning device;
a workflow dispatcher configured to:
split the order into at least one sub-order, and
insert a second message for placing the sub-order into a queue; and
a sender to configured to:
retrieve the second message from the queue, and
send the second message to a database server.

12. The device of claim 11, wherein the queue includes a first-in-first-out (FIFO) synchronized queue.

13. The device of claim 11, wherein the queue includes:
a semaphore that synchronizes processes accessing the queue.

14. The device of claim 11, wherein the order includes:
a request to assign a telephone number to an address outside of a geographical region that is associated with an area code of the telephone number.

15. The device of claim 11, wherein the database server includes:
a catalog of telephone numbers and associated addresses.

16. The device of claim 11, further comprising:
a timeout handler that determines whether a process for handling the order has timed out.

17. The device of claim 11, further comprising logic to respond to a remote client program that requests information about the order.

18. The device of claim 11, further comprising:
a database table that includes a record corresponding to the sub-order, the record storing at least a status of the sub-order.

19. The device of claim 12, wherein the listener is further configured to:
store a file that corresponds to the first message in a directory to indicate that the order has been received.

20. A method comprising:
receiving a sub-order to assign a telephone number to an address, via a first message from a remote device;
translating the first message into a second message that a catalog server can parse;
submitting the second message to the catalog server;
receiving a response from the catalog server, the response indicating whether the telephone number is assigned to the address;
sending a reply to the remote device, the reply including content of the response; and
receiving an acknowledgment from the remote device.

21. The method of claim 20, further comprising:
locking a queue that includes the reply;
decoding the reply;
removing the reply from the queue; and
unlocking the queue.

22. The method of claim 21, wherein unlocking the queue includes:
decrementing a semaphore count.

23. The method of claim 20,
receiving, at the remove device, an order associated with a set of telephone numbers and an address;
separating the order into sub-orders that include the sub-order, each of the sub-orders corresponding to each of the telephone numbers; and
sending the sub-order from the remote device to a catalog server device.

24. The method of claim 23, further comprising:
sending an acknowledgment from the catalog server device to the remote device, to indicate that the catalog server device has received the sub-order.
